(19) United States
(12) Patent Application Publication
(10) Pub. No.: US 2023/0410272 A1
(43) Pub. Date: Dec. 21, 2023

(54) SYSTEMS AND METHODS FOR AIR CARGO CONTAINER DAMAGE MONITORING

(71) Applicant: GOODRICH CORPORATION, Charlotte, NC (US)

(72) Inventors: Nitin Kumar Goyal, Bangalore (IN); Ashutosh Kumar Jha, Bangalore (IN)

(73) Assignee: GOODRICH CORPORATION, Charlotte, NC (US)

(21) Appl. No.: 17/888,796

(22) Filed: Aug. 16, 2022

(30) Foreign Application Priority Data
May 20, 2022 (IN) 202241029166

(51) Int. Cl. G06T 7/00

(52) U.S. Cl. CPC G06T 7/0002; G06T 2207/30232; G06T 2207/20081

(57) ABSTRACT

A method of monitoring cargo loading by an aircraft field device may be used to detect damage to cargo and ULDs, reducing the need for manual inspection of the cargo and/or eliminate the need for constant human monitoring of cargo loading. The method may comprise scanning ULDs and receiving image data of the ULDs, and sending the data to an on ground infrastructure network. The on ground infrastructure network may classify ULD type and classify damage to the ULDs. The damage classification may be received by the field device. The field device may generate an alert and/or halt cargo loading in response to the damage classification.

### CROSS-REFERENCE TO RELATED APPLICATIONS

This application claims priority to, and the benefit of, India Patent Application No. 202241029166, filed May 20, 2022 (DAS Code 5FC7) and titled “SYSTEMS AND METHODS FOR AIR CARGO CONTAINER DAMAGE MONITORING,” which is incorporated by reference herein in its entirety for all purposes.

### FIELD

The present disclosure relates generally to aircraft cargo management, more specifically, identification of cargo damage.

### BACKGROUND

Aircraft cargo compartments are used to carry luggage and other cargo during a flight. Air cargo containers, such as Unit Load Devices (ULDs), are used for loading cargo into aircraft. ULDs and cargo pallets are typically made of aluminum and come in standardized shapes and sizes configured for bulk loading a large quantity of cargo. They also allow cargo to be efficiently loaded and fastened inside the aircraft, reducing loading time and the risk of cargo and/or aircraft damage.

Many cargo and passenger aircraft are equipped with semi-automatic Cargo Loading System (CLS) in the compartment. The CLS is an electrically powered system that allows Unit Load Devices (ULDs) to be carried into the aircraft cargo compartment. The primary benefit of the CLS is to reduce the manpower and loading/unloading time during shipment. One of the many risks to shipping cargo via aircraft is cargo damage. Improper cargo stacking, damaged cargo containers, and improper fastening of cargo have damaged aircraft fuselages, on-board cargo equipment, aircraft doors, and the like. Moreover, damaged ULDs with uneven surfaces may block movement by jamming the CLS motor drives, causing unexpected delays. Accordingly, ULDs need to be visually inspected before being loaded into the aircraft.

### SUMMARY

A method for monitoring cargo loading is disclosed herein. In various embodiments, the method may comprise receiving, by a field device, image data of cargo from a camera. In various embodiments, the method may comprise interfacing, by the field device, the field device with an on ground infrastructure network. In various embodiments, the interfacing may comprise sending by the field device, the image data to the on ground infrastructure network. The interfacing may further comprise receiving, by the field device, feedback from the on ground infrastructure network, wherein the feedback may comprise a damage classification. The method may further comprise instructing, by the field device, a cargo loading system to halt cargo loading in response to the damage classification.

In various embodiments, the method may comprise processing, by the field device, the image data. The processing may further comprise filtering, by the field device, the image data. The processing may further comprise compressing, by the field device, the image data. The processing may further comprise performing, by the field device, image segmentation and representation. The processing may further comprise performing, by the field device, image extraction.

In various embodiments, the interfacing may further comprise transmitting, by the field device, a unit load device configuration to the on ground infrastructure network, wherein the on ground infrastructure network may be configured to select a trained AI-based Analytics Model based on the unit load device configuration. In various embodiments, the sending may comprise sending, by the field device, image data processed by the field device to the on ground infrastructure network, wherein the on ground infrastructure network may be configured to process the image data and may be further configured to perform a damage classification using the selected trained AI-based Analytics Model.

In various embodiments, the method may comprise receiving, by the field device, a damage report from the on ground infrastructure network. The interfacing may further comprise receiving, by the field device, an instruction from the on ground infrastructure network for a unit load device scan. In various embodiments, the receiving, by the field device, image data from the camera may comprise the field device electronically communicating with the camera. In various embodiments, the method may comprise commanding, by the field device, the camera to adjust a view of the cargo.

A method for monitoring cargo loading is also disclosed herein. The method may comprise receiving, by an on ground infrastructure network, image data of cargo from a camera. In various embodiments, the method may comprise directing, by the on ground infrastructure network, the camera to activate, wherein the camera may be configured to capture image data. In various embodiments, the method may comprise initiating, by the on ground infrastructure network, a sensor to scan a unit load device.

The method may further comprise interfacing, by the on ground infrastructure network, the on ground infrastructure network with the field device. The interfacing may further comprise receiving, by the on ground infrastructure network, the image data from the field device. In various embodiments, the method may comprise sending, by the on ground infrastructure network, feedback from the field device, wherein the feedback may comprise a damage classification. In various embodiments, the method may further comprise monitoring, by the on ground infrastructure network, loading of cargo based on the damage classification. The method may further comprise instructing, by the on ground infrastructure network, a cargo loading system to halt cargo loading in response to the damage classification.

In various embodiments, the interfacing may further comprise receiving, by the on ground infrastructure network, a unit load device scan from the field device. The interfacing may further comprise extracting, by the on ground infrastructure network, a unit load device configuration. The interfacing may further comprise selecting, by the on ground infrastructure network, a trained AI-based Analytics Model based on the unit load device configuration. The interfacing may further comprise processing, by the on ground infrastructure network, the image data. The interfacing may further comprise performing, by the on ground infrastructure network, a damage classification using the selected trained AI-based Analytics Model. In various embodiments, the initiating may further comprise selecting, by the on ground infrastructure network, one of an RFID scan, barcode scan, or text scan.

A method for monitoring cargo loading is also disclosed herein. In various embodiments, the method may comprise receiving, by a field device, image data of cargo from a camera. In various embodiments, the method may comprise interfacing, by the field device, the field device with an aircraft avionics system. In various embodiments, the method may comprise interfacing, by the field device, the field device with on ground infrastructure network. In various embodiments, the interfacing may comprise sending by the field device, the image data to the on ground infrastructure network. The interfacing may further comprise receiving, by the field device, feedback from the on ground infrastructure network, wherein the feedback may comprise a damage classification. The method may further comprise instructing, by the field device, a cargo loading system to halt cargo loading in response to the damage classification.

In various embodiments, the instructing may comprise instructing, by the field device, a movement controller of the cargo loading system. In various embodiments, the instructing may further comprise reversing, by the field device, the movement controller of the cargo loading system. In various embodiments, the method may comprise generating, by the field device, an alarm based on the damage classification. The generating may further comprise transmitting, by the field device, the alarm to the aircraft avionics system.

### BRIEF DESCRIPTION OF THE DRAWINGS

FIG. 1 illustrates a method for identifying a ULD configuration, in accordance with various embodiments;

FIG. 2 illustrates a method for identifying a ULD configuration, in accordance with various embodiments;

FIG. 3 illustrates a method for identifying a ULD configuration, in accordance with various embodiments;

FIG. 4 illustrates a method for training and validating an AI-based Analytics Model for damage detection of a unit load device, in accordance with various embodiments;

FIG. 5 illustrates a method for training and validating an AI-based Analytics Model for damage identification, in accordance with various embodiments;

FIG. 6 illustrates a block spread of a unit load device, in accordance with various embodiments;

FIG. 7 illustrates a method for generating an AI-based Analytics Model for unit load device damage detection, in accordance with various embodiments;

FIG. 8 illustrates a method for scanning cargo for damage in real-time, in accordance with various embodiments;

FIG. 9 illustrates a method for scanning cargo for damage in real-time, in accordance with various embodiments;

FIG. 10A illustrates a method for monitoring cargo loading, in accordance with various embodiments;

FIG. 10B illustrates a method for monitoring cargo loading, in accordance with various embodiments; and

FIG. 11 illustrates a method for monitoring cargo loading, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “electronic communication” means communication of electronic signals with physical coupling (e.g., “electrical communication” or “electrically coupled”) or without physical coupling and via an electromagnetic field (e.g., “inductive communication” or “inductively coupled” or “inductive coupling”). In this regard, “electronic communication,” as used herein, includes wired and wireless communications (e.g., Bluetooth, TCP/IP, Wi-Fi, etc.). Additionally, as used herein, “Bluetooth” is a low-power, short-range wireless radio communication.

As used herein, “transmit” may include sending electronic data from one system component to another over a network connection. Additionally, as used herein, “data” may include encompassing information such as commands, queries, files, data for storage, and the like in digital or any other form. As used herein, “Machine Learning” may be, for example, a method of data analysis that automates analytical model building. For example, a method of data analysis that automates analytical model building may be referred to as an “AI-based Analytics Model.” Additionally, as used herein, “Deep Learning” may be a subset of Machine Learning, comprising multiple layers of analysis.

As disclosed herein, “cargo,” “cargo containers,” and “unit load devices (ULDs)” may be interchangeably used to refer to aircraft cargo. As will be discussed in further detail below, an aircraft and aircraft cargo loading systems may contain multiple image sensors, cameras, and motion sensors placed at different locations within the aircraft or on cargo loading systems near the aircraft, such that the sensors and cameras may cover a 360-degree view of cargo as the cargo is loaded into the aircraft. These systems may also be placed on a tarmac, along a cargo loading ramp, and/or along the cargo bay door of the aircraft to scan cargo as it moves into and out of the cargo bay. These systems may be commanded by an onboard device, such as, for example, a field device, to scan the cargo as cargo enters and traverses within the cargo bay. The field device may be, for example, an aircraft interface device (AID). These systems may capture image data and relay the data to the field device. Image data may be, for example, images, three-dimensional scans, and video feeds of cargo. The field device may process the data and may interface with and relay data to on board video storage systems, avionics systems aboard the aircraft, and on ground infrastructure network. On ground infrastructure network may use Machine Learning and/or pre-trained AI-based Analytics Models to identify and classify cargo damage and defects. The on ground infrastructure network may do this by comparing the cargo being scanned to an appropriate predetermined ULD configuration. ULD configuration information may be stored with the on ground infrastructure network and may be selected by the on ground infrastructure network based on cargo details retrieved from a QR (Quick Response) code, barcode, text, and/or RFID-based (radio-frequency identification) tag. Cargo details may be model numbers and serial numbers associated with the ULDs. On ground infrastructure network may be, for example, the cloud.

As will be described in further detail below, the AI-based Analytics Model may be trained to identify cargo damage. This model may be trained to detect irregularities in shape and size of cargo or unit load device (ULD) containers and classify the cargo as damaged. The on ground infrastructure network may provide feedback to the field device, which may, in turn, instruct a cargo loading system (CLS) to halt cargo loading or reverse cargo loading, enabling timely removal of damaged cargo.

Accordingly, a method of monitoring cargo loading by the field device may be used to detect damage to cargo and ULDs, reducing the need for manual inspection of cargo on a cargo loading ramp or in the cargo bay and/or eliminate the need for constant human monitoring of cargo loading.

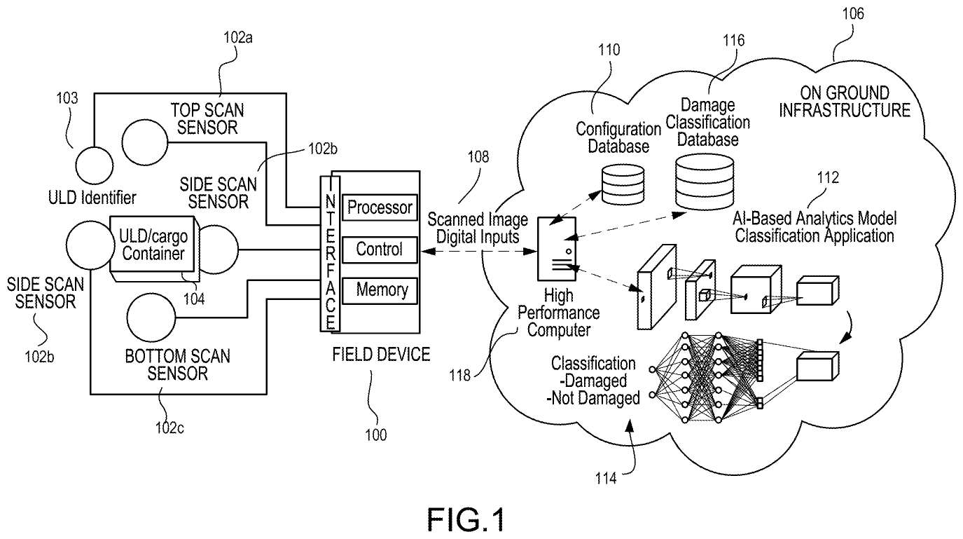

Referring to FIGS. 1-3, a method for identifying a ULD configuration is shown in accordance with various embodiments.

An shown in FIG. 1, to identify ULD damage, the field device 100 may command sensors 102a, 102b, 102c and a ULD identifier 103 to capture details of the ULD 104 (e.g., scanning the ULD), and may relay details of the scanned ULD 104 to the on ground infrastructure network 106 in the form of scanned image digital inputs 108 (e.g., image data). These details may include a serial number and model number of the ULD 104, three-dimensional scans of the ULD 104, and/or images of the ULD 104.

There are several ULD types and configurations approved to be loaded as aircraft cargo. Accordingly, since each ULD 104 differs in shape and size, the on ground infrastructure network 106 may first identify the particular ULD configuration of the scanned ULD 104 before classifying damage to the ULD 104. The on ground infrastructure network 106 may choose a configuration from a configuration database 110 stored in the on ground infrastructure network 106. In identifying the associated ULD configuration, the on ground infrastructure network 106 may select a pre-trained AI-based Analytics Model associated with the configuration. This may be an AI-based classification application 112 that is specific to the ULD configuration. Accordingly, a ULD damage classification analysis 114 may be tailored to the specific ULD configuration.

As will be discussed in further detail below, the on ground infrastructure network 106 may comprise a damage classification database that enables the AI-based application 112 (e.g., the AI-based Analytics Model) to perform the damage classification analysis 114, analyzing the scanned ULD for irregularities. The on ground infrastructure network 106 may comprise a high performance computer 118 that may provide computing power for processing and analysis.

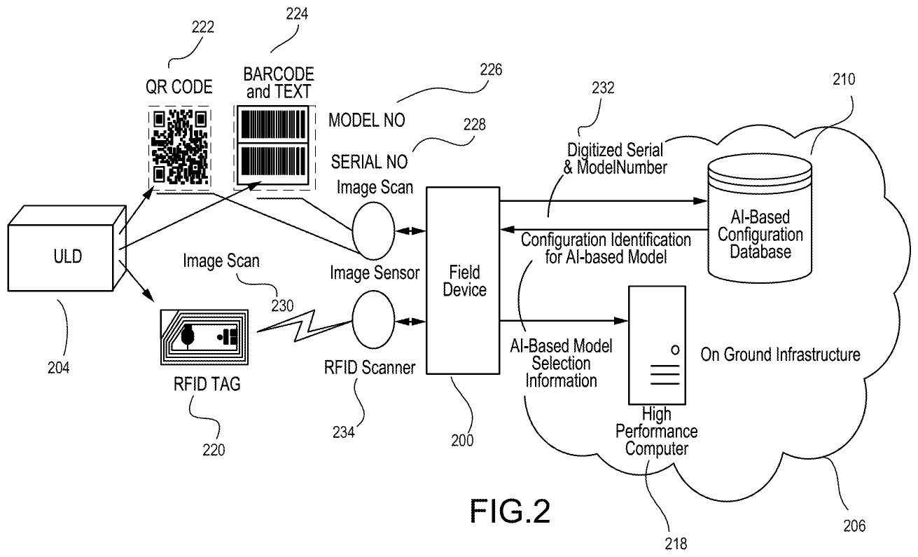

As shown in FIG. 2, each ULD 204 may include a unique identification number, which may be presented to a sensor (or ULD identifier) in the form of an RFID tag 220, QR code 222, barcode and text 224, and the like. The unique identification number may comprise the model 226 and serial numbers 228 of the ULD 204. The field device 200 may initiate a scan 230 of the ULD identification number, retrieve the number, store the number, and relay the number to the on ground infrastructure network. In various embodiments, the field device 200 may digitize the serial and model numbers and relay digitized serial and model numbers 232 to the on ground infrastructure network 206. Accordingly, the field device 200 may convert the ULD serial and model number 232 to a format configured to be read by the on ground infrastructure network. In various embodiments, configuration identification may be performed by the field device 200 over a wireless communication channel, such as, for example, Bluetooth or Wi-Fi, wherein a receiver on the ULD interfaces with the field device.

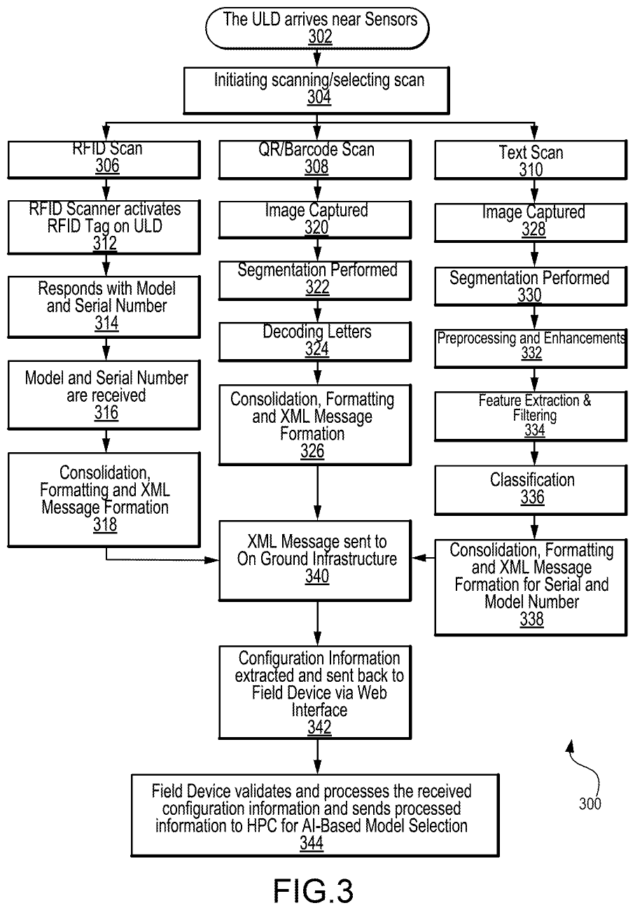

FIG. 3 illustrates a method 300 for configuration identification. As shown, the ULD may arrive (step 302) near the sensors (e.g., sensors 102a, 102b, 102c, and/or ULD identifier 103 shown in FIG. 1). The field device may initiate (step 304) scanning by selecting the type of scan required. The field device may select at least one of an RFID scan (step 306), a QR/barcode scan (step 308), and/or a text scan (step 310). Proceeding with an RFID scan (step 306), an RFID scanner (FIG. 2, 234) may activate (step 312) an RFID tag on the ULD. The RFID tag on the ULD may respond (step 314) to a scan, transmitting the model and serial number to the RFID scanner. The model and serial number may be received (step 316) by the field device via the scanner. The field device may consolidate, format, and perform (step 318) an XML (extensible markup language) message formation for the serial and model numbers.

Proceeding with a QR/barcode scan (step 308), the field device may direct a camera to capture (step 320) an image and transmit the image to the field device. The field device may perform (step 322) image segmentation and decode (step 324) the letters in the image. The field device may consolidate, format, and perform (step 326) an XML message formation for the serial and model numbers.

Proceeding with a text scan (step 310), the field device may direct a camera to capture (step 328) an image and transmit the image to the field device. The field device may perform (step 330) image segmentation. The field device may then preprocess and enhance (step 332) the image. The field device may perform feature extraction and filter the image (step 334). The field device may classify (step 336) the image, identifying the model number and serial number of the ULD. The field device may consolidate, format, and perform (step 338) an XML (extensible markup language) message formation for the serial and model numbers.

Proceeding with either the RFID scan (step 306), QR/barcode scan (step 308), or the text scan (step 310), the field device may transmit (step 340) an XML message to on ground infrastructure network (e.g., the cloud) to obtain a ULD configuration. The field device and the on ground infrastructure network may be connected via a web interface. The on ground infrastructure network may extract (step 342) ULD configuration information from a database and send the configuration to the field device. The field device may validate and process (step 344) the received configuration information and send the processed information to a high performance computer (HPC) of the on ground infrastructure network. The HPC of the on ground infrastructure network may be configured for AI-based model selection, which may be used to compare the ULD to a pre-set scan of the ULD.

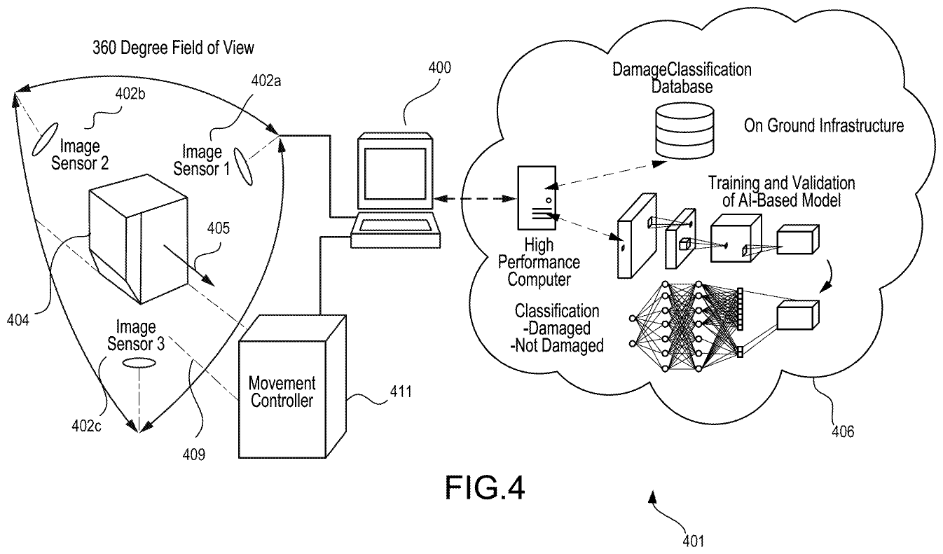

Referring to FIG. 4, a method for monitoring cargo loading is shown in accordance with various embodiments. Specifically, a method 401 for training and validating an AI-based Analytics Model for damage identification is shown. In various embodiments, the AI-based Analytics Model may be an AI-based Analytics Model of on ground infrastructure network 406 that detects damage in a ULD 404. This AI-based model may be trained under lab conditions using forward and backward 405 propagation techniques to establish a relationship between images of normal and damaged ULDs and a scanned image received from a field device 400. As shown, the ULD 404 may be moved along a sliding rail 409 by a movement controller 411 as cameras and image sensors 402a, 402b, 402c capture a 360 degree field of view of the ULD 404.

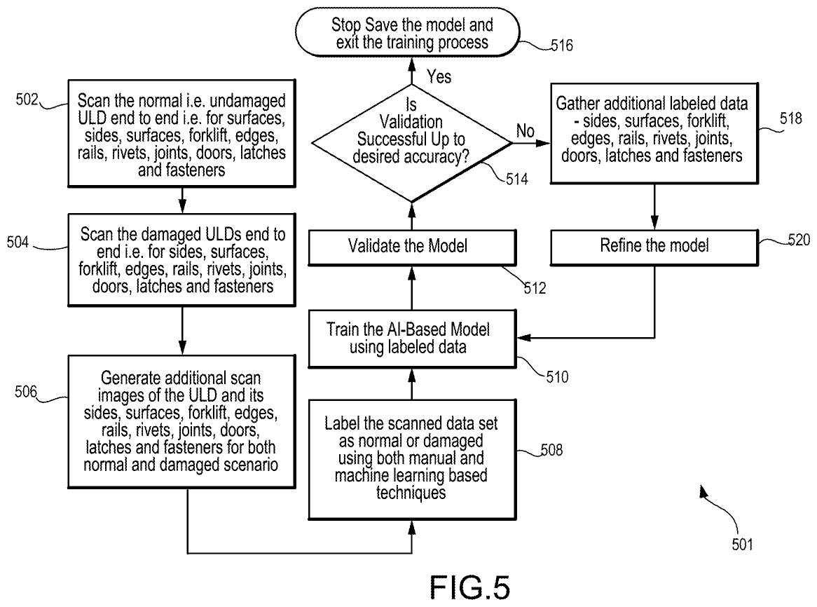

The method 501 for training and validating the AI-based Analytics Model for damage identification is further shown in FIG. 5. In various embodiments, the method 501 may comprise scanning (step 502) an undamaged (e.g., normal) ULD. The method may further comprise scanning (step 504) a damaged ULD. In various embodiments, the method may comprise generating (step 506) additional scanned images of the ULD. The scanned data set may be labeled (step 508) or identified as normal or damaged using both manual and machine learning based techniques. The method may further comprise training (step 510) the AI-based Analytics Model (e.g., model) using the labeled data. In various embodiments, the AI-based Analytics Model may be validated (step 512). The validation may be measured against a desired accuracy (step 514). If the validation is successful up to the desired accuracy, the training is complete, and the AI-based Analytics Model saved (step 516) to the on ground infrastructure network. If the validation does not achieve the desired accuracy, the method may comprise gathering (step 518) additional labeled data (e.g., scans). This data may include scans of ULD sides, surfaces, forklift edges, rails, rivets, joints, doors, latches, and fasteners. The method may further comprise refining (step 520) the model using the additional data, wherein the additional data may be used to train the AI-based Analytics Model.

To increase training precision, the sensors may also be used to capture the ULD at various areas and near various components of a hypothetical cargo loading system and/or cargo bay, such as, for examples, near forklift edges, rails, rivets, joints, doors, latches, and the like. ULDs used during this training may be normal, undamaged ULDs, as well as damaged ULDs to enable the on ground infrastructure network to classify the ULDs as normal or damaged. In various embodiments, the training and validating of the AI-based Analytics Model may occur in real-time, simultaneous with real-time monitoring. For example, as a new kind of defect or damage is identified, the AI-based Analytics Model may be trained for a new damage classification, and the on ground infrastructure network may be updated based on the new training data. In various embodiments, scanned images of the ULDs may be supplemented with computer generated images. These images may be fed into the AI-based Analytics Model of the on ground infrastructure network. This may enable the network to avoid under fitting or over fitting the classification data and increase classification precision.

For every type of ULD, a respective AI-based Analytics Model may be identified. These models may be trained on the type of ULD for which training is in progress. The various trained models may be stored along with the associated ULD configuration in the on ground infrastructure network. This may enable the on ground infrastructure network to activate the relevant trained model during real time damage detection.

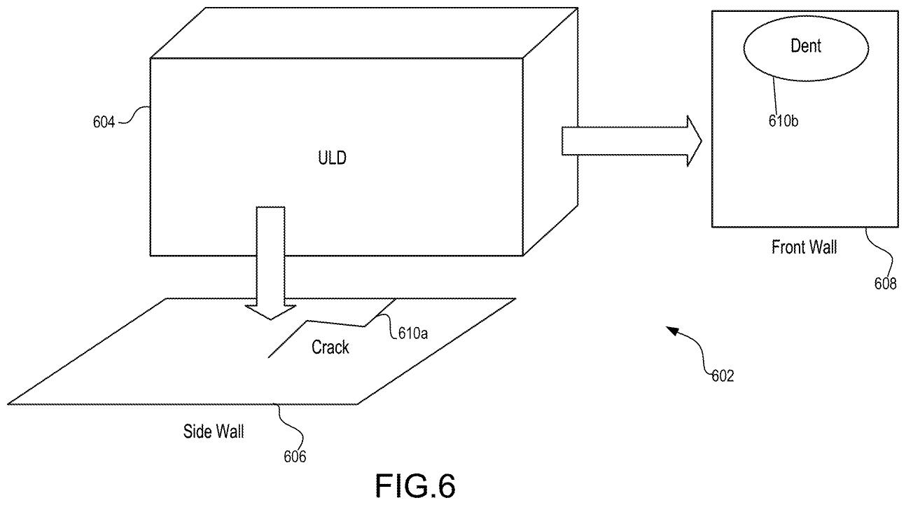

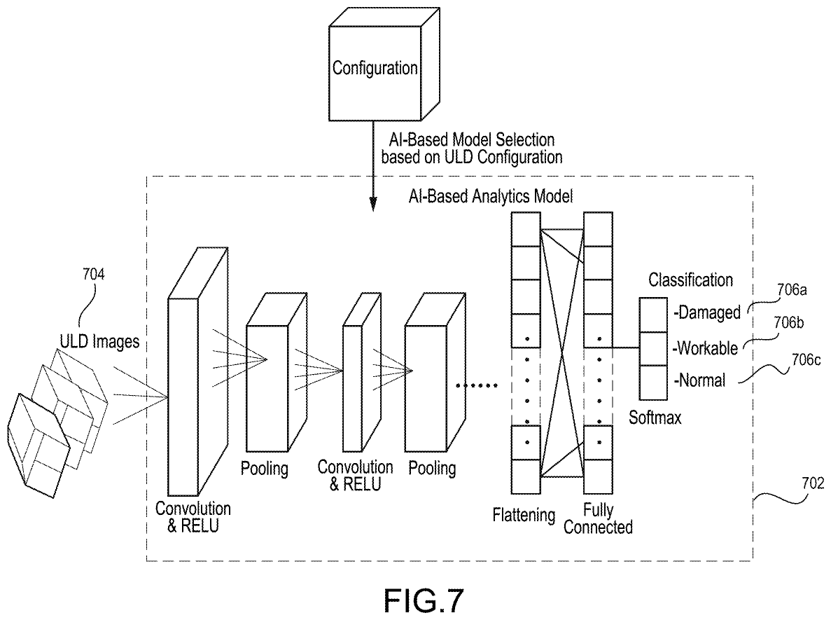

Referring to FIG. 6, a block spread 602 of a ULD 604 is shown in accordance with various embodiments. The AI-based Analytics Model may divide the scanned surfaces of the ULD 604 into blocks or segments (e.g., as shown, side wall 606 and front wall 608). Accordingly, any damage to the ULD 604 may be captured at the block level. In various embodiments, the on ground infrastructure network may render a complete ULD scan and transmit the scan back to the field device. The field device may then render or display the damaged areas or regions 610a, 610b. As shown in FIG. 7, the AI-based network 702 may generate a model which incorporates digital data 704 sent by the field device. The network 702 may process the digital data by fitting in spatial and temporal dependencies to perform classification of damaged 706a, workable 706b, or normal 706c ULD regions of interest (e.g., sides, surfaces, forklift edges, rails, rivets, joints, doors, latches, and fasteners).

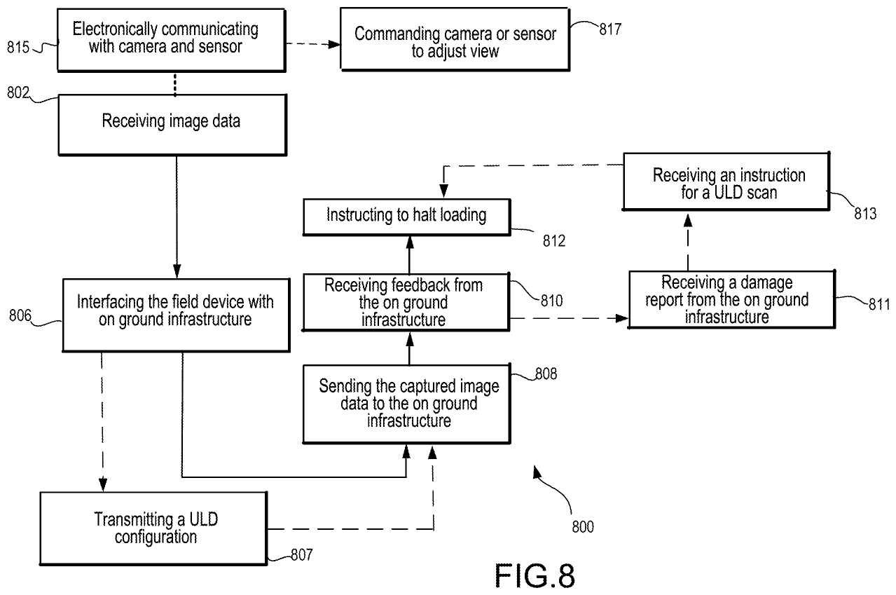

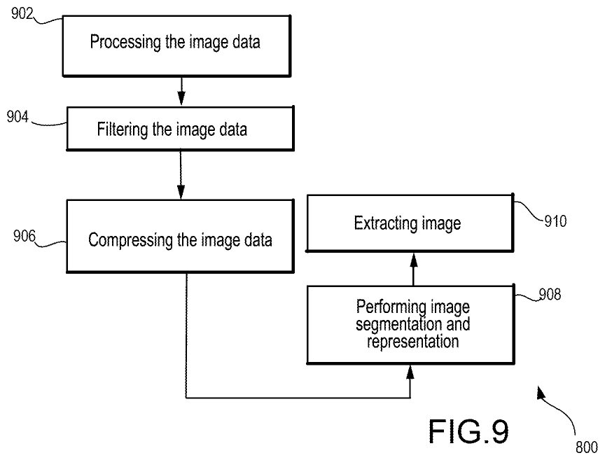

Referring to FIGS. 8 and 9, a method for monitoring cargo loading is shown in accordance with various embodiments. Specifically, a method 800 for scanning cargo for damage in real-time is shown in FIG. 8, in accordance with various embodiments.

In various embodiments, the method may comprise receiving (step 802), by a field device, image data of cargo from a camera. In various embodiments, the method 800 may comprise interfacing (step 806), by the field device, the field device with on ground infrastructure network. In various embodiments, the interfacing (step 806) may comprise sending (step 808) by the field device, the image data to the on ground infrastructure network. The interfacing (step 806) may further comprise receiving (step 810), by the field device, feedback from the on ground infrastructure network, wherein the feedback may comprise a damage classification. The method 800 may further comprise instructing (step 812), by the field device, a cargo loading system to halt cargo loading in response to the damage classification. Instructing the cargo loading system to halt cargo loading may allow removal of a damaged unit load device from the cargo loading system.

In various embodiments, the interfacing (step 806) may further comprise transmitting (step 807), by the field device, a unit load device configuration to the on ground infrastructure network, wherein the on ground infrastructure network may be configured to select a trained AI-based Analytics Model based on the unit load device configuration. In various embodiments, the sending (step 808) may comprise sending, by the field device, image data processed by the field device to the on ground infrastructure network, wherein the on ground infrastructure network may be configured to process the image data and may be further configured to perform a damage classification using the selected trained AI-based Analytics Model.

In various embodiments, the method 800 may comprise receiving (step 811), by the field device, a damage report from the on ground infrastructure network. The interfacing may further comprise receiving (step 813), by the field device, an instruction from the on ground infrastructure network for a unit load device scan. In various embodiments, the receiving (step 802), by the field device, image data of cargo from the camera may comprise the field device electronically communicating (step 815) with the camera. In various embodiments, the method 800 may comprise commanding (step 817), by the field device, the camera to adjust a view of the cargo.

With reference to FIG. 9, in various embodiments, the method 800 may comprise processing (step 902), by the field device, the image data. The processing (step 902) may further comprise filtering (step 904), by the field device, the image data. The processing (step 902) may further comprise compressing (step 906), by the field device, the image data. The processing (step 902) may further comprise performing, by the field device, image segmentation and representation (step 908). The processing (step 902) may further comprise performing, by the field device, image extraction (step 910).

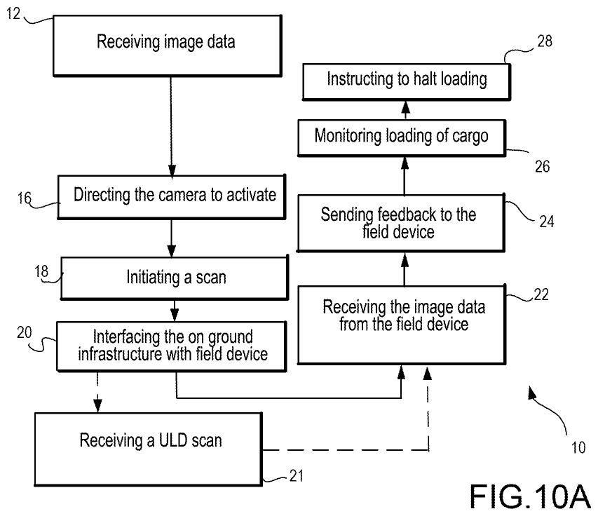

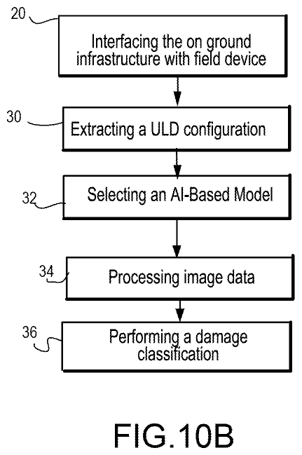

A method for monitoring cargo loading is also disclosed herein. The method (10, FIG. 10A) may comprise receiving (step 12), by an on ground infrastructure network, image data of cargo from a camera. In various embodiments, the method 10 may comprise directing (step 16), by the on ground infrastructure network, the camera to activate, wherein the camera may be configured to capture image data of cargo. In various embodiments, the method 10 may comprise initiating (step 18), by the on ground infrastructure network, a sensor to scan a unit load device. In various embodiments, the initiating (step 18) may further comprise selecting, by the field device, one of an RFID scan, barcode scan, or text scan.

The method may further comprise interfacing (step 20), by the on ground infrastructure network, the on ground infrastructure network with the field device. The interfacing (step 20) may further comprise receiving (step 22), by the on ground infrastructure network, the image data from the field device. In various embodiments, the method 10 may comprise sending (step 24), by the on ground infrastructure network, feedback to the field device, wherein the feedback may comprise a damage classification. In various embodiments, the method 10 may further comprise monitoring (step 26), by the on ground infrastructure network, loading of cargo based on the damage classification. The method 10 may further comprise instructing (step 28), by the on ground infrastructure network, a cargo loading system to halt cargo loading in response to the damage classification. Instructing the cargo loading system to halt cargo loading may be configured to allow removal of a damaged unit load device from the cargo loading system.

In various embodiments, the interfacing (step 20) may further comprise receiving (step 21), by the on ground infrastructure network, a unit load device scan from the field device. As shown in FIG. 10B, the interfacing (step 20) may further comprise extracting (step 30), by the on ground infrastructure network a unit load device configuration. The interfacing (step 20) may further comprise selecting (step 32), by the on ground infrastructure network, a trained AI-based Analytics Model based on the unit load device configuration. The interfacing (step 20) may comprise processing (step 34), by the on ground infrastructure network, the image data. The interfacing (step 20) may further comprise performing (step 36), by the on ground infrastructure network, a damage classification using the selected trained AI-based Analytics Model.

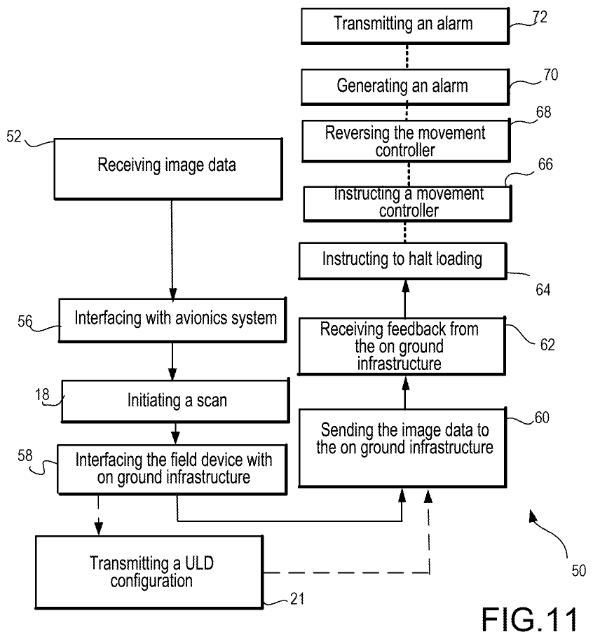

Additional embodiments of the present disclosure may comprise a method (50, FIG. 11) comprising receiving (step 52), by a field device, image data of cargo from a camera. In various embodiments, the method 50 may comprise interfacing (step 56), by the field device, the field device with an aircraft avionics system. In various embodiments, the method 50 may comprise interfacing (step 58), by the field device, the field device with on ground infrastructure network. In various embodiments, the interfacing (step 58) may comprise sending (step 60) by the field device, the image data to the on ground infrastructure network. The interfacing (step 58) may further comprise receiving (step 62), by the field device, feedback from the on ground infrastructure network, wherein the feedback may comprise a damage classification. The method 50 may further comprise instructing (step 64), by the field device, a cargo loading system to halt cargo loading in response to the damage classification. Instructing the cargo loading system to halt cargo loading may be configured to allow removal of a damaged unit load device from the cargo loading system.

In various embodiments, the instructing (step 64) may comprise instructing (step 66), by the field device, a movement controller of the cargo loading system. In various embodiments, the instructing (step 66) may further comprise reversing (step 68), by the field device, the movement controller of the cargo loading system. In various embodiments, the method 50 may comprise generating (step 70), by the field device, an alarm based on the damage classification. The generating (step 70) may further comprise transmitting (step 72), by the field device, the alarm to the aircraft avionics system. In various embodiments, an alarm may be generated by the field device and transmitted by the field device to a device controlled by cargo loading personnel, such as, for example, a cargo loading control panel and/or handheld device. It may be understood that an alarm may be transmitted to any device used to manage and/or monitor cargo loading. The present disclosure is not limited in that regard.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for monitoring cargo loading, comprising:
receiving, by a field device, image data of cargo from a camera;
interfacing, by the field device, the field device with an on ground infrastructure network, wherein the interfacing further comprises:
sending, by the field device, the image data to the on ground infrastructure network; and
receiving, by the field device, feedback from the on ground infrastructure network, wherein the feedback comprises a damage classification; and
instructing, by the field device, a cargo loading system to halt cargo loading in response to the damage classification.

2. The method of claim 1, further comprising processing, by the field device, the image data.

3. The method of claim 2, wherein the processing further comprises filtering, by the field device, the image data.

4. The method of claim 3, wherein the processing further comprises compressing, by the field device, the image data.

5. The method of claim 4, wherein the interfacing further comprises transmitting, by the field device, a unit load device configuration to the on ground infrastructure network, wherein the on ground infrastructure network is configured to select a trained AI-based Analytics Model based on the unit load device configuration.

6. The method of claim 5, wherein the sending further comprises sending, by the field device, image data processed by the field device to the on ground infrastructure network, wherein the on ground infrastructure is configured to process the image data and is further configured to perform a damage classification using the selected trained AI-based Analytics Model.

7. The method of claim 6, further comprising receiving, by the field device, a damage report from the on ground infrastructure network.

8. The method of claim 7, wherein the interfacing further comprises receiving, by the field device, an instruction from the on ground infrastructure network for a unit load device scan.

9. The method of claim 1, wherein the receiving, by the field device, image data from the camera comprises the field device electronically communicating with the camera.

10. The method of claim 1, further comprising commanding, by the field device, the camera to adjust a view of the cargo.

11. The method of claim 2, wherein the processing further comprises performing, by the field device, image segmentation and representation.

12. The method of claim 11, wherein the processing further comprises performing, by the field device, image extraction.

13. A method for monitoring cargo loading, comprising:
receiving, by an on ground infrastructure network, image data of cargo from a camera;
directing, by the on ground infrastructure network, the camera to activate, wherein the camera is configured to capture image data;
initiating, by the on ground infrastructure network, a sensor to scan a unit load device;
interfacing, by the on ground infrastructure network, the on ground infrastructure network with a field device, wherein the interfacing further comprises:
receiving, by the on ground infrastructure network, the image data from the field device; and
sending, by the on ground infrastructure network, feedback to the field device, wherein the feedback comprises a damage classification;
monitoring, by the on ground infrastructure network, loading of cargo based on the damage classification; and
instructing, by the on ground infrastructure network, a cargo loading system to halt cargo loading in response to the damage classification.

14. The method of claim 13, wherein the interfacing further comprises:
receiving, by the on ground infrastructure network, a unit load device scan from the field device;
extracting, by the on ground infrastructure network, a unit load device configuration;
selecting, by the on ground infrastructure network, a trained AI-based Analytics Model based on the unit load device configuration;
processing, by the on ground infrastructure network, the image data; and
performing, by the on ground infrastructure network, a damage classification using the selected trained AI-based Analytics Model.

15. The method of claim 14, wherein the initiating further comprises selecting, by the on ground infrastructure network, one of an RFID scan, barcode scan, or text scan.

16. A method for monitoring cargo loading, comprising:
receiving, by a field device, image data of cargo from a camera;
interfacing, by the field device, the field device with an aircraft avionics system;
interfacing, by the field device, the field device with an on ground infrastructure network, wherein the interfacing further comprises:
sending, by the field device, the image data to the on ground infrastructure network; and
receiving, by the field device, feedback from the on ground infrastructure network, wherein the feedback comprises a damage classification; and
instructing, by the field device, a cargo loading system to halt cargo loading in response to the damage classification.

17. The method of claim 16, wherein the instructing further comprises instructing, by the field device, a movement controller of the cargo loading system.

18. The method of claim 17, wherein the instructing further comprises reversing, by the field device, the movement controller of the cargo loading system.

19. The method of claim 16, further comprising generating, by the field device, an alarm based on the damage classification.

20. The method of claim 19, wherein the generating further comprises transmitting, by the field device, the alarm to the aircraft avionics system.
